(19) United States
(12) Patent Application Publication
(10) Pub. No.: US 2013/0039529 A1
(43) Pub. Date: Feb. 14, 2013

(54) SPEAKER

(71) Applicant: ASEN Lab Co., LTD., Incheon (KR)

(72) Inventors: Suk-Joo KIM, Seoul (KR); Dong-Chol Heo, Incheon (KR)

(73) Assignee: ASEN Lab Co., LTD., Incheon (KR)

(21) Appl. No.: 13/656,768

(22) Filed: Oct. 22, 2012

Related U.S. Application Data
(63) Continuation of application No. PCT/KR2011/002428, filed on Apr. 6, 2011.

(30) Foreign Application Priority Data
Apr. 20, 2010 (KR) 10-2010-0036260
Mar. 23, 2011 (KR) 10-2011-0025784

(51) Int. Cl. H04R 1/00

(52) U.S. Cl. 381/412

(57) ABSTRACT

In configuring a magnetic circuit, by forming polarities of a magnet to be aligned along a vertical direction, and by optimizing a yoke providing a flow path of a magnetic flux, a vibration system is formed inside a magnetic circuit, so that a height of a speaker can be remarkably reduced. Additionally, by increasing a volume of the magnet and a diameter of a bobbin, a speaker with enhanced sound effect characteristics may be provided herein.

### CROSS REFERENCE TO PRIOR APPLICATIONS

This application is a Continuation Application of a PCT International Patent Application No. PCT/KR2011/002428 (filed on Apr. 6, 2011), which claims priority to Korean Patent Application Nos. 10-2010-0036260 (filed on Apr. 20, 2010) and 10-2011-0025784 (filed on Mar. 23, 2011), which are all hereby incorporated by reference in their entirety.

### BACKGROUND

The present invention relates to a speaker and, more particularly, to a speaker having a remarkably low height and showing excellent performance.

Generally, a speaker refers to a device that converts electrical signals to sound that can be heard through our ears. A speaker may either be used separately, or may be used as an assembly part of an electronic device. Recently, the electronic devices are becoming smaller in size and lighter in weight. Accordingly, the speaker being applied to the electronic devices are also required to become smaller in size and lighter in weight and to show more excellent performance.

FIG. 1 and FIG. 2 illustrate cross-sectional views showing a related art magnetically shielded speaker. The speaker shown in FIG. 1 and FIG. 2 is mostly used as a PC speaker and a full-range TV speaker.

As shown in FIG. 1, in the related art speaker, a cone-shaped frame (17) and a magnetically shielding cap (16) configure an outside feature of the speaker. The inside of the magnetically shielding cap (16) is provided with a main magnet (1), which functions as a magnetic flux source, and a yoke (5), which provides a flow path for a magnetic flux generated from the main magnet (1). The yoke (5) includes a top plate (3) and a bottom plate (2). The top plate (3) is configured to have a ring shape, wherein a center portion is removed from a circular plate, and the bottom plate (2) is configured to have the shape of a circular plate, and the bottom plate is provided with a pole (4) having a cylindrical shape, which rises from the bottom plate (2).

The magnetic flux, which is generated by the main magnet (1), is guided by the yoke (5) and then meets a break point of the yoke (5), which is also referred to as a magnetic gap. Referring to FIG. 1, a gap formed between the pole (4) and the top plate (3) corresponds to the magnetic gap.

Meanwhile, a ring-shaped magnetically shielding magnet (15) is located at a lower surface of the bottom plate (2). The magnetically shielding magnet (15) is used to prevent a magnetic field, which is generated from the main magnet (1), from influencing other electronic components located outside of the speaker. Additionally, in order to effectively block the magnetic field generated from the main magnet (1), the magnetically shielding cap (16) covers the outer surface of the main magnet (1) and the magnetically shielding magnet (15).

As shown in FIG. 2, the main magnet (1), the yoke (5), the magnetically shielding magnet (15), the magnetically shielding cap (16), and the magnetic gap collectively configure a magnetic circuit. Herein, a magnetic circuit refers to a device providing a magnetic flux, which allows the speaker to convert the electrical signals to sound.

Meanwhile, a voice coil (7) is located within the magnetic gap. Herein, the voice coil (7) is wound around a bobbin (6) having a cylindrical shape, and the bobbin (6) is connected to a diaphragm (8), which has a cone-like shape. Accordingly, when the voice coil (7) is supplied with electrical signals, the voice coil (7) performs vertical movements in accordance with Fleming's rule. Then, such vertical movements are delivered to the diaphragm (8) along the bobbin. The diaphragm (8) performs a function of converting such movements to sound. Herein, a damper (10) is provided, so as to support the bobbin (6) and to control the vibration range of the diaphragm (8).

A lead wire (12) is connected to the voice coil (7), so as to supply the electrical signals. The lead wire (12) is generally adhered along the surface of the diaphragm (8) and then passes through a hole formed in the frame (17), so as to be connected to a terminal (13).

As shown in FIG. 2, the diaphragm (8), the voice coil (7), and the bobbin (6) collectively configures a vibration system (22). Herein, a vibration system refers to a device that converts electrical signals to sound, by performing movements within a magnetic field in accordance with the inputted electrical signals.

Meanwhile, a dust cap (11) is provided at the center of the diaphragm (8), so as to prevent dust from flowing into the magnetic gap.

The related art speaker performs the following operations. When an electrical signal is supplied to the voice coil (7) through the terminal (13) and the lead wire (12), in accordance with Fleming's rule, the voice coil (7) located in the magnetic gap performs vertical movements, which are perpendicular to the magnetic field, and such movements are delivered to the diaphragm (8). The movements that are delivered to the diaphragm (8) vibrate the diaphragm (8), thereby converting the electrical signals to sound.

The related art speaker shown in FIG. 1 and FIG. 2 has the following disadvantages. In the related art speaker, since the magnetic circuit (21) and the vibration system (22) form a vertical layers, the height of the speaker is increased. More specifically, the total height of the speaker is decided by adding the thickness of the magnetic circuit and the thickness of the vibration system.

The speaker shown in FIG. 1 and FIG. 2 is mostly used as a PC speaker or an LCD TV speaker. However, despite the recent trend of TVs becoming slimmer, it is difficult to reduce the thickness of the TV any further due to the tall height of the speaker.

Additionally, due to the outside structure and magnetic shielding structure, it is inevitable to reduce the size of the main magnet, which configures the magnetic circuit. However, if the thickness of the magnet is reduced, a magnetic flux density of the magnetic gap is also reduced accordingly, thereby causing a decrease in sound pressure of the speaker.

Furthermore, due to many components, the cost for manufacturing is also increased.

FIG. 3 illustrates a cross-sectional view of a related art a speaker for middle and low frequency sound. The speaker shown in FIG. 3 corresponds to a speaker that is used for an audible frequency bandwidth within the range of 60 Hz˜3 KHz. The overall structure of the speaker is similar to that of the speaker shown in FIG. 1 and FIG. 2. However, the device for performing magnetic shielding is not provided herein. The speaker shown in FIG. 3 is mostly used as a speaker equipped in vehicles, a household speaker, and so on, and the speaker shown herein has the following disadvantages.

First of all, when the speaker shown in FIG. 3 is equipped to a vehicle, due to the height of the speaker, it is difficult to increase the volume of the magnet (31), thereby causing a problem of low sound pressure. More specifically, the speaker is required to be equipped in a limited space within a door trim of the vehicle. However, the height of the related art speaker is decided based upon the combined thickness of the magnetic circuit and the vibration system. Therefore, when installing the related art speaker in a vehicle, it is inevitable to reduce the size of the magnet within the magnetic circuit.

If the size of the magnetic circuit is reduced, due to the weight of the voice coil, it is inevitable to use a voice coil having a larger diameter. Accordingly, in addition to the difficulty in generating high output, a decrease in the durability of the speaker may be caused due to the voice coil having a lower diameter. Additionally, since the diameter of the bobbin becomes lower, the winding of the voice coil should be increased, thereby causing an increase in the winding width of the voice coil. Therefore, when the voice coil performs the vertical movements, the voice coil may touch the bottom plate (36). Accordingly, the height of the pole (37), which is connected to the bottom plate (36), is increased, thereby causing the overall height of the speaker to be increased.

Meanwhile, as the width of the wound voice coil is increased, a considerable portion of the wound voice coil deviates from the center of the magnetic gap, thereby causing a loss in the frequency bandwidth, which then leads to an increase in f0 (minimum reproduction threshold frequency).

Furthermore, since the speaker requires components, such as a frame (33), a dust cap (34), a gasket (38), and so on, the manufacturing procedure becomes more complicated, and the fabrication cost is increased.

FIG. 4 illustrates a cross-sectional view of a first embodiment of a related art speaker for high frequency sound. The speaker shown in FIG. 4 corresponds to a speaker that is used for an audible frequency bandwidth within the range of 2 KHz˜20 KHz. And, the speaker shown in FIG. 4 is mostly used as a speaker used in vehicles, a household speaker, and so on.

As shown in FIG. 4, in the related art speaker for high frequency sound, a frame (62) forms the outer shape of the speaker. The inside the frame (62) is equipped with a yoke (55) providing a flow path of the magnetic flux, which is generated from a magnet (51). The yoke (55) includes a top plate (54) having the shape of a circular plate, and a bottom plate (52) having a cylindrical shape and a lower surface, wherein an opening is formed at the center of the lower surface. A ring-shaped magnet (51) is placed between the bottom plate (52) and the top plate (54). Meanwhile, a magnetic gap is formed between the bottom plate (52) and the top plate (54).

As shown in FIG. 4, the magnet (51), the yoke (55), and the magnetic gap collectively configures a magnetic circuit.

Meanwhile, a voice coil (56) is located in the magnetic gap. Herein, the voice coil (56) is connected to a diaphragm (57). In accordance with the electrical signals supplied to the voice coil (56), the voice coil (56) performs vertical movements, which are delivered to the diaphragm (57). Then, as the diaphragm (57) vibrates, the electrical signals are converted to sound.

A lead wire (60) is connected to the voice coil (56), so as to supply the electrical signals. The lead wire (60) is connected to a terminal (61), thereby being capable of receiving electrical signals from an outside source.

The speaker for a high frequency shown in FIG. 4 is provided with a first sound absorbent (58) and a second sound absorbent (59). Therefore, high quality sound may be provided by minimizing diffraction, a reflection wave, and a standing wave caused by a backside vibrating sound of the diaphragm (57)

However, due to an increase in the overall height of the speaker, the speaker occupies a larger space for installing. Additionally, since the heat generated from the voice coil (56) cannot be discharged, frequent malfunction may occur in the speaker.

FIG. 5 illustrates a cross-sectional view of a second embodiment of a related art speaker for high frequency sound. As shown in FIG. 5, in the related art speaker for a high frequency, a frame (72) forms the outer structure of the speaker. The inside the frame (72) is equipped with a yoke (83) providing a flow path of the magnetic flux, which is generated from a magnet (71). The yoke (83) includes a top plate (81) having the shape of a circular plate, and a bottom plate (82) having a cylindrical shape and a blocked lower surface. The magnet having circular shape (71) is placed between the bottom plate (82) and the top plate (81). Meanwhile, a magnetic gap is formed between the bottom plate (82) and the top plate (81).

As shown in FIG. 5, the magnet (71), the yoke (83), and the magnetic gap collectively configures a magnetic circuit.

Meanwhile, a voice coil (84) is placed in the magnetic gap. The voice coil (84) is wound around a bobbin (85), and the bobbin (85) is connected to a diaphragm (76) in order to deliver the vertical movements of the voice coil (84) to the diaphragm (76). A first cover (77), which is configured of a plastic material produced by an injection manner, is formed above the diaphragm (76), and the first cover (77) functions as an equalizer for enhancing the characteristics of the audible frequency bandwidth. Meanwhile, a second cover (78), which is formed of a mesh-like material, is formed above the first cover (77), and the second cover (78) protects the internal devices, such as the diaphragm (76).

A terminal (79) is used for supplying electrical signals to the voice coil (84), and the terminal (79) is supported by a fixing unit (74). Meanwhile, the bottom plate (82) is fixed to the frame (72) by a magnetic circuit supporting unit (73).

The tall height of the speaker for a high frequency shown in FIG. 5 also causes a difficulty in installing the speaker in vehicles. And, since the lower portion of the diaphragm (76) is blocked, diffraction caused by lower surface vibrating sound of the diaphragm and a problem of a reflection wave and a standing wave may occur. Therefore, high quality sound cannot be provided, and due to a large number of components, the manufacturing procedure becomes more complicated, and the fabrication cost is increased. Meanwhile, since the heat generated from the voice coil (84) cannot be discharged, frequent malfunction may occur in the speaker.

### SUMMARY OF THE INVENTION

An object of the present invention is to provide a speaker that can obviate the above-described problems occurring in the related art invention, by providing a speaker having more enhanced sound and a remarkably reduced size.

In order to achieve the above-described technical object of the present invention, a speaker includes a magnetic circuit and a vibration system, and wherein the magnetic circuit includes a magnet having a ring shape, wherein a lower surface part has a first polarity, and wherein an upper surface part has a second polarity, a first plate being fixed to the lower surface part of the ring-shaped magnet and extending towards a center of the ring, a first magnetic gap providing unit being connected to the first plate and protruding upwards toward the first plate, a second plate being fixed to the upper surface part of the ring-shaped magnet and extending towards a center of the ring, and a second magnetic gap providing unit being connected to the second plate and protruding upwards toward the second plate.

When configuring the magnetic circuit, by forming the polarity of the magnet along a vertical direction, and by changing the shape of the yoke, which provides a flow path of the magnetic flux, the present invention may form a vibration system inside the magnetic circuit.

A speaker according to the present invention has the following advantages.

First of all, by increasing the magnetic flux intensity, the present invention may provide a high output sound pressure.

Secondly, by decreasing the height of the speaker as thin as possible, the size of the electronic device installed the speaker may also be reduced.

Thirdly, by using a bobbin having a large diameter, a voice coil having a larger diameter may be wound around the bobbin, thereby increasing the input and output of the speaker.

Fourthly, with a decrease in the number of components, the manufacturing process of the speaker is more simplified. Accordingly, the speaker may be manufactured by means of automated production, thereby reducing the manufacturing cost.

Finally, since the heat generated from the voice coil can be immediately discharged, the durability of the speaker may be enhanced.

### BRIEF DESCRIPTION OF THE DRAWINGS

FIG. 1 and FIG. 2 illustrate cross-sectional views showing a related art magnetically shielded magnet speaker.

FIG. 3 illustrates a cross-sectional view of a related art speaker for middle and low frequency sound.

FIG. 4 illustrates a cross-sectional view of a first embodiment of a related art speaker for high frequency sound.

FIG. 5 illustrates a cross-sectional view of a second embodiment of a related art speaker for high frequency sound.

FIG. 6 illustrates a cross-sectional view of a magnetic circuit according to an exemplary embodiment of the present invention.

FIG. 7 illustrates a cross-sectional view of a speaker according to a first embodiment of the present invention.

FIG. 8 illustrates a cross-sectional view of a speaker according to a second embodiment of the present invention.

FIG. 9 illustrates a cross-sectional view of a speaker according to a third embodiment of the present invention.

FIG. 10 illustrates a cross-sectional view of a speaker according to a fourth embodiment of the present invention.

FIG. 11 illustrates a graph showing a sound pressure and frequency characteristics of the speaker shown in FIG. 1 and the speaker according to the first embodiment of the present invention.

FIG. 12 illustrates a graph showing a sound pressure and frequency characteristics of a related art 4-inch speaker and the speaker according to the third embodiment of the present invention.

### DETAILED DESCRIPTION OF THE INVENTION

The above-described technical objects, characteristics, and advantages of the present invention will be more clarified based upon the following detailed description of the present invention, which will be given with reference to the accompanying drawings. The preferred embodiments of the present invention will hereinafter be described in more detail with reference to the accompanying drawings.

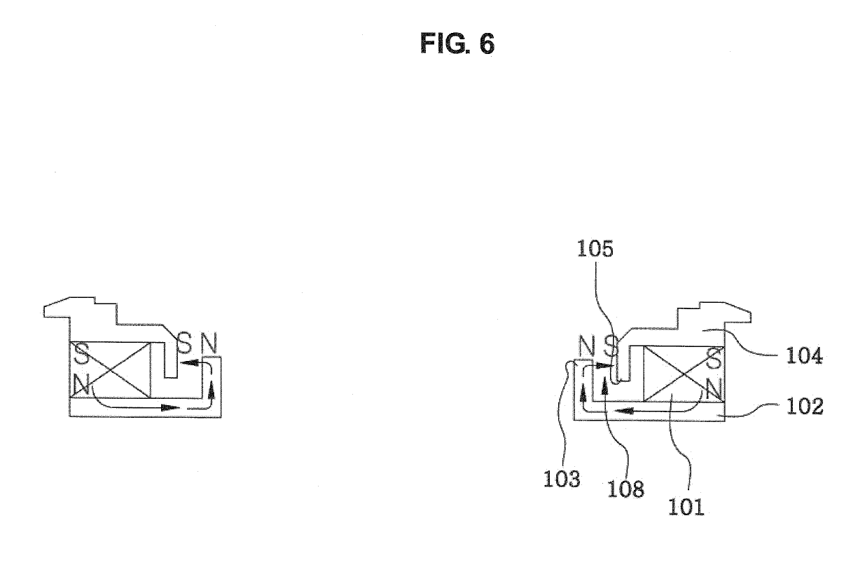

FIG. 6 illustrates a cross-sectional view of a magnetic circuit according to an exemplary embodiment of the present invention. Referring to FIG. 6, the magnetic circuit according to the present invention is configured by including a magnet (101), a first plate (102), a second plate (104), a first magnetic gap providing unit (103), a second magnetic gap providing unit (105), and a magnetic gap (108).

The magnet (101) is configured to have a ring shape. However, herein, in addition to a circular ring shape, the ring shape may also include a rectangular ring shape, an elliptic ring shape, and track shape. The lower surface of the magnet (101) is fixed to the first plate (102). The first plate (102) not only supports the magnet (101) but is also formed to be extended further towards a center portion of the ring. Additionally, the inner edge, which extends from the first plate (102), forms the first magnetic gap providing unit (103), which is projected upwards. Meanwhile, an upper surface of the magnet (101) is fixed to the second plate (104). The second plate (104) not only covers the magnet (101) but also has a structure extending further towards the center of the ring. Furthermore, the inner edge, which extends from the second plate (104), forms the second magnetic gap providing unit (105), which is projected downwards.

A gap between the first magnetic gap providing unit (103) and the second magnetic gap providing unit (105) configures the magnetic gap (108).

In the magnetic circuit according to the present invention, since the first plate (102), the second plate (104), the first magnetic gap providing unit (103), and the second magnetic gap providing unit (105) provide a flow path for the magnetic flux generated from the magnet (101), the first plate (102), the second plate (104), the first magnetic gap providing unit (103), and the second magnetic gap providing unit (105) collectively perform the function of a yoke.

Referring to FIG. 6, although it is shown that an S pole is formed at the upper portion of the magnet (101), and that an N pole is formed at the lower portion of the magnet (101), it will be apparent that the N pole may also be formed at the upper portion of the magnet (101), and that the S pole may also be formed at the lower portion of the magnet (101).

According to the embodiment shown in FIG. 6, the magnetic flux, which begins from the lower N pole of the magnet (101), passes through the first plate (102), the first magnetic gap providing unit (103), the second plate (104), and the second magnetic gap providing unit (105), so as to reach the upper S pole. Herein, the magnetic circuit of the speaker according to the present invention is configured in accordance with the above-described flow of the magnetic flux.

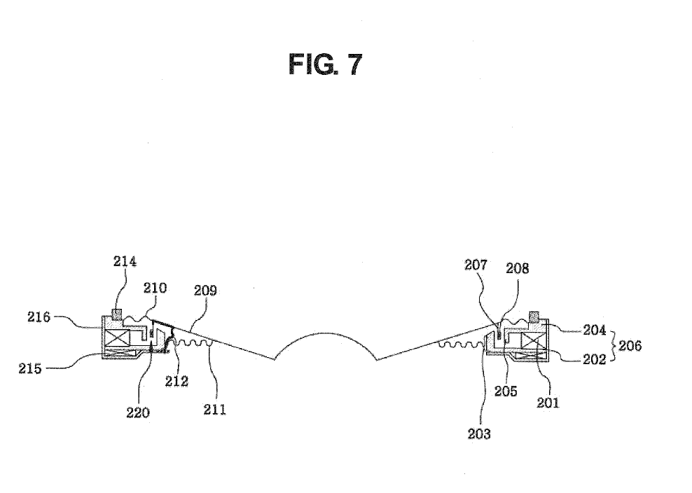

FIG. 7 illustrates a cross-sectional view of a speaker according to a first embodiment of the present invention. In this embodiment of the present invention, the magnetic circuit is configured based upon the characteristics of the magnetic circuit shown in FIG. 6.

The magnetic circuit of the speaker according to the present invention is configured by including a magnet (201), a first plate (202), a second plate (204), a first magnetic gap providing unit (203), a second magnetic gap providing unit (205), and a magnetic gap (220).

The magnet (201) forms an N pole and an S pole along the vertical direction. Meanwhile, the magnet (201) is formed to have a ring shape. Herein, it is preferable that the magnet (201) has an elliptic ring shape or a track shape. The first plate (202) is fixed to a lower surface of the magnet (201), and the second plate (204) is fixed to an upper surface of the magnet (201). The first plate not only supports the magnet (201) but is also formed to be extended further towards a center portion of the ring. Meanwhile, the second plate not only covers the upper surface of the magnet (201) but also has a structure extending further towards the center of the ring.

The first magnetic gap providing unit (203) is projected upwards from the extended portion of the first plate (202), and the second magnetic gap providing unit (205) is projected downwards from the extended portion of the second plate (204). The first magnetic gap providing unit (203) and the second magnetic gap providing unit (205) are spaced apart from one another at a predetermined distance so as to form a gap, which corresponds to the magnetic gap (220).

Since the first plate (202), the second plate (204), the first magnetic gap providing unit (203), and the second magnetic gap providing unit (205) provide a flow path for the magnetic flux generated from the magnet (201), the first plate (202), the second plate (204), the first magnetic gap providing unit (203), and the second magnetic gap providing unit (205) collectively perform the function of a yoke.

Being provided with a step structure having the shape of a staircase starting from the outer portion to the inner portion of the ring, it is preferable that the upper surface of the second plate (204) is easily fixed to the diaphragm (209) without requiring a separate jig.

A vibration system of the speaker according to the present invention is configured by including a diaphragm (209), a bobbin (207), a voice coil (208), and an edge part (210). The voice coil (208) is wound around the bobbin (207), and the bobbin (207) is connected to the diaphragm (209). It is preferable that the diaphragm (209) is formed in a cone shape having a dome formed at a center portion. The central dome form of the diaphragm (209) enhances the frequency characteristic of the audible bandwidth and reduces the height of the diaphragm (209). Meanwhile, it is preferable that the outer circumference of the diaphragm (209) is formed to have an elliptic shape or track shape in accordance with the ring shape of the magnet (201).

The voice coil (208) is placed in the magnetic gap (220), which is formed by the first magnetic gap providing unit (203) and the second magnetic gap providing unit (205). The voice coil (208) has a winding width of approximately 2 mm, and it is preferable that the voice coil is formed in a single winding layer.

The voice coil (208) is wound around the bobbin (207), and the bobbin (207) performs the function of delivering the movements of the voice coil (208) according to the supplied electrical signals to the diaphragm (209). It is preferable that the bobbin (207) is formed to have an elliptic shape or a track shape in accordance with the ring shape of the magnet (201). Meanwhile, as compared to the related art bobbin, the bobbin (207) according to the present invention has a remarkably more increased diameter.

The edge part (210) is fixed to the step structure of the second plate (204), and it is preferable that the edge part (210) has a wave form. The edge part (210) is connected to the diaphragm (209) and the step structure of the second plate (204), so as to perform not only the function of facilitating the vibration of the diaphragm (209), but also the function of controlling a vibration range of the diaphragm (209).

It is preferable that the speaker according to the embodiment of the present invention is equipped with a damper (211), which supports the diaphragm (209) and controls the vibration range of the diaphragm (209). Herein, one end of the damper (211) is fixed to an inner surface of the first magnetic gap providing unit (203), and another end of the damper (211) is fixed to the diaphragm (209). Also, preferable, in order to provide increase air permeability, a plurality of vent holes is formed in the damper (211).

A lead wire (212) is connected to the voice coil (208), so as to deliver AMP signals of an outside source to the voice coil (208). Herein, it is preferable that a gasket (214) having elasticity is fixed to the step structure of the second plate (204). When the speaker according to the embodiment of the present invention is equipped inside another electronic device, the gasket (204) not only allows the diaphragm (209) to vibrate easily, but also prevents noise caused by resonance from occurring between the diaphragm (209) and a case of the electronic device.

Additionally, the speaker according to the embodiment of the present invention may include a component for performing magnetic shielding. For example, by fixing a magnetically shielding magnet (215) to a lower surface of the first plate (202), and by covering the structure with a magnetically shielding cap (216), the magnetic flux generated from the magnet (201) may be prevented from flowing outside of the speaker.

As described above, in the speaker according to the present invention, since the height of the speaker is decided by the height of the ring-shaped magnet (or the height of the magnetic circuit), a speaker having a thickness that is remarkably reduced as compared to the related art speaker may be provided. More specifically, in the related art speaker, since the vibration system is formed above the magnetic circuit, the thickness of the speaker is equal to the combined height of the magnetic circuit and the vibration system. However, according to the present invention, since the vibration system is enveloped by the magnetic circuit, the height of the magnetic circuit decides the thickness of the speaker. Accordingly, the thickness of the speaker is reduced as much as the height of the vibration system. Furthermore, the intensity of a magnetic field of the magnetic circuit depends upon the volume of the magnet, and, in the speaker according to the present invention, since the magnet forms the outer circumference of the speaker, the thickness of the magnet may be reduced while maintaining the volume of the magnet. Accordingly, the height of the magnetic circuit may also be reduced.

Moreover, as the outer circumference of the ring-shaped magnet increases, the diameter of the bobbin, which is wound by the voice coil, is also increased. Thus, a high sound pressure may be provided. Furthermore, since the yoke performs the function of a frame, which forms the outer structure of the speaker, a separate frame is omitted. And, therefore, the size of the magnetic circuit may be increased accordingly.

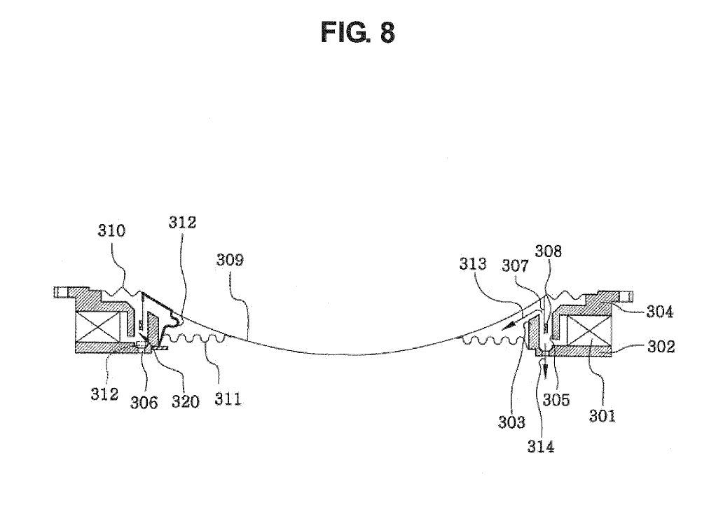

FIG. 8 illustrates a cross-sectional view of a speaker according to a second embodiment of the present invention. In this embodiment of the present invention, the magnetic circuit shown in FIG. 6 is applied to the speaker according to the embodiment of the present invention.

The magnetic circuit of the speaker according to the present invention is configured by including a magnet (301), a first plate (302), a second plate (304), a first magnetic gap providing unit (303), a second magnetic gap providing unit (305), and a magnetic gap (320).

The magnet (301) forms an N pole and an S pole along the vertical direction. Meanwhile, the magnet (301) is formed to have a ring shape. Herein, the magnet (301) may have a circular, elliptic, rectangular, or track ring shape. The first plate (302) is fixed to a lower surface of the magnet (301), and the second plate (304) is fixed to an upper surface of the magnet (301). The first plate not only supports the magnet (301) but is also formed to be extended further towards a center portion of the ring. Meanwhile, the second plate not only covers the upper surface of the magnet (301) but also has a structure extending further towards the center of the ring.

The first magnetic gap providing unit (303) is projected upwards from the extended portion of the first plate (302), and the second magnetic gap providing unit (305) is projected downwards from the extended portion of the second plate (304). The first magnetic gap providing unit (303) and the second magnetic gap providing unit (305) are spaced apart from one another at a predetermined distance so as to form a gap, which corresponds to the magnetic gap (320).

Since the first plate (302), the second plate (304), the first magnetic gap providing unit (303), and the second magnetic gap providing unit (305) provide a flow path for the magnetic flux generated from the magnet (301), the first plate (302), the second plate (304), the first magnetic gap providing unit (303), and the second magnetic gap providing unit (305) collectively perform the function of a yoke.

Preferably, the first plate (302) has a groove (312) and a plurality of vent holes (306). The vent holes (306) are formed in order to discharge the heat generated from the voice coil (308), and the groove (312) is formed in order to prevent the voice coil (308) from touching the first plate (302), when performing vertical movements in accordance with an instant output of the voice coil (308). The arrows (313, 314) of the drawing indicate paths through which the heat being generated from the voice coil (308) is discharged. As indicated by the arrows (313, 314), the heat generated from the voice coil (308) may be discharged not only through the vent hole (306) formed in the first plate (302), but also along the direction of the center of the speaker from the magnetic gap (320). As described above, when the heat is easily discharged, the durability of the speaker may be enhanced.

Being provided with a step structure having the shape of a staircase starting from the outer portion to the inner portion of the ring, it is preferable that the upper surface of the second plate (304) is easily fixed to the diaphragm (309) without requiring a separate jig.

A vibration system of the speaker according to the present invention is configured by including a diaphragm (309), a bobbin (307), a voice coil (308), and an edge part (310). The voice coil (308) is wound around the bobbin (307), and the bobbin (307) is connected to the diaphragm (309). It is preferable that the diaphragm (309) is formed in an inverted dome shape.

The voice coil (308) is placed in the magnetic gap (320), which is formed by the first magnetic gap providing unit (303) and the second magnetic gap providing unit (305). It is preferable that the winding width of the voice coil (308) is set to 3.2 mm, and that the wire diameter is set to φ0.25 for the durability of the speaker.

According to the present invention, since the voice coil (308) is always present in the magnetic circuit not only during a low output but also during a high output, the f0 (minimum reproduction threshold frequency) is decreased, thereby enhancing the characteristics of a low frequency band.

The voice coil (308) is wound around the bobbin (307), and the bobbin (307) performs the function of delivering the movements of the voice coil (308) according to the supplied electrical signals to the diaphragm (309). Meanwhile, as compared to the related art bobbin, the bobbin (307) according to the present invention has a remarkably more increased diameter.

The edge part (310) is fixed to the step structure of the second plate (304), and it is preferable that the edge part (310) has a wave form. The edge part (310) is connected to the diaphragm (309) and the step structure of the second plate (304), so as to perform not only the function of facilitating the vibration of the diaphragm (309), but also the function of controlling a vibration range of the diaphragm (309).

It is preferable that the speaker according to the embodiment of the present invention is equipped with a damper (311), which supports the diaphragm (309) and controls the vibration range of the diaphragm (309). Herein, one end of the damper (311) is fixed to an inner surface of the first magnetic gap providing unit (303), and another end of the damper (311) is fixed to the diaphragm (309). A lead wire (312) is connected to the voice coil (308), so as to deliver AMP signals of an outside source to the voice coil (308).

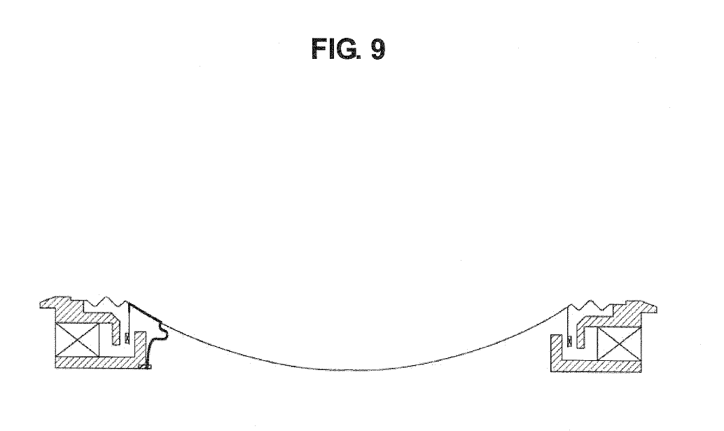

FIG. 9 illustrates a cross-sectional view of a speaker according to a third embodiment of the present invention. In this embodiment of the present invention, the magnetic circuit shown in FIG. 6 is applied to the speaker according to the embodiment of the present invention.

As shown in FIG. 9, the speaker according to the third embodiment of the present invention has the same basic structure as the speaker according to the second embodiment of the present invention. However, unlike the speaker according to the second embodiment of the present invention, the speaker according to the third embodiment of the present invention is not equipped with a damper. This is because, since the speaker according to the third embodiment of the present invention is mostly used in a middle frequency band, the vibration amplitude of the diaphragm is not large with respect to a band of 300 Hz and higher.

According to the embodiment of the present invention, it is preferable that a highly durable aluminum coil is used for the voice coil. Additionally, it is also preferable that the winding width of the voice coil is set to 2.5 mm, and that the voice coil is formed of a single winding layer.

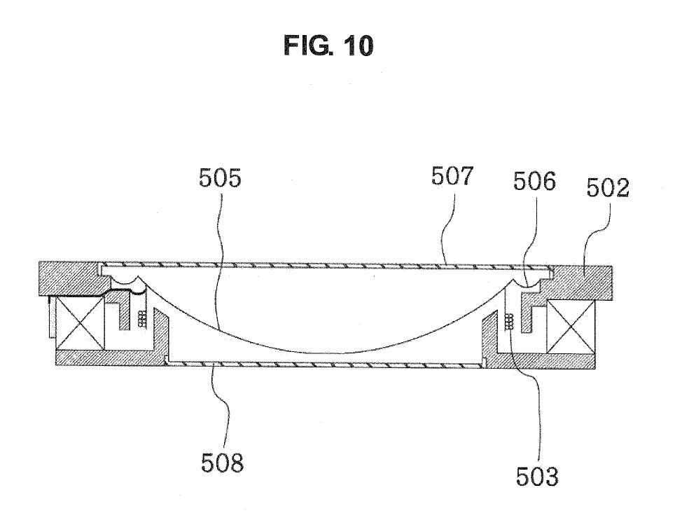

FIG. 10 illustrates a cross-sectional view of a speaker according to a fourth embodiment of the present invention. In this embodiment of the present invention, the magnetic circuit shown in FIG. 6 is applied to the speaker according to the embodiment of the present invention.

As shown in FIG. 9, the speaker according to the third embodiment of the present invention has the same basic structure as the speaker according to the second embodiment of the present invention. However, unlike the speaker according to the second embodiment of the present invention, the speaker according to the fourth embodiment of the present invention includes a vent hole cap (507) and a lower surface part (508), and the edge part (506) is formed to have a ribbed shape.

Since the speaker according to the fourth embodiment of the present invention is more adequate for high frequency sound, by forming to the edge part (506) to have a ribbed structure, a rough high frequency sound may become more natural and refined. Additionally, it is preferable to form the mesh-like vent hole cap (507) with a metallic substance. Moreover, it is also preferable to create a plurality of vent hole discharge openings through which sound can be outputted. It is also preferable to form the lower surface part (508) to have a mesh-like structure by using a metallic substance, just as the vent hole cap (507). By minimizing diffraction in a lower surface vibrating sound of the diaphragm (505), a reflection wave, and a standing wave, the lower surface part (508) may provide high sound quality. Furthermore, by facilitating the discharge of the heat being generated from the voice coil (503), the lower surface part (508) may enhance the durability of the speaker.

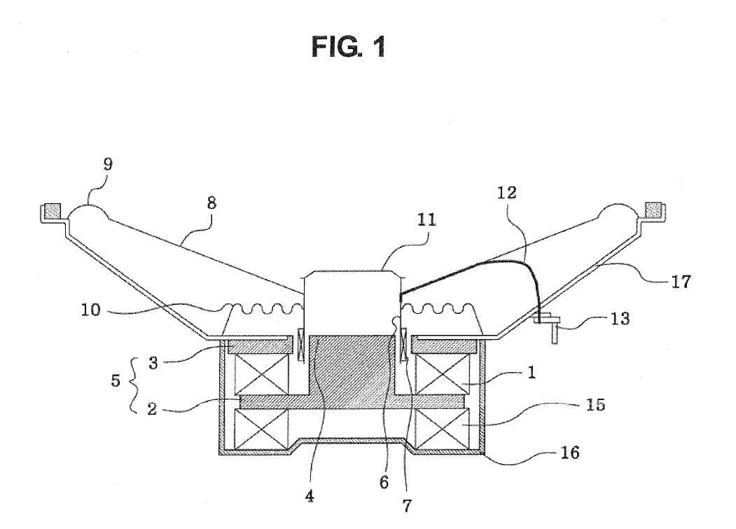

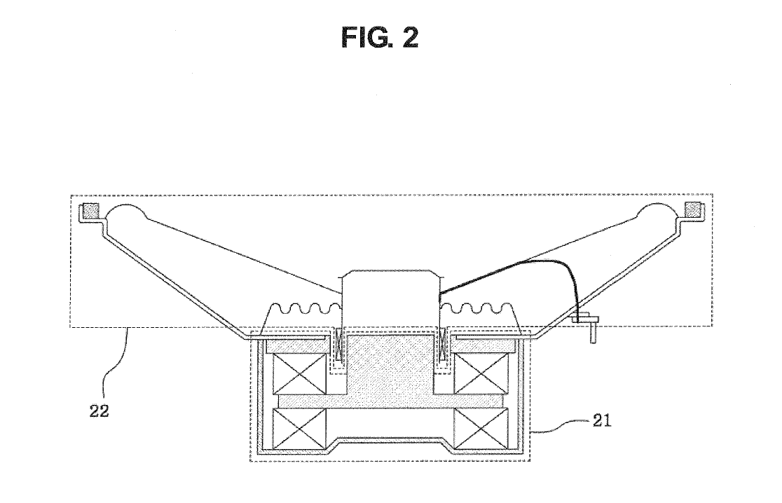

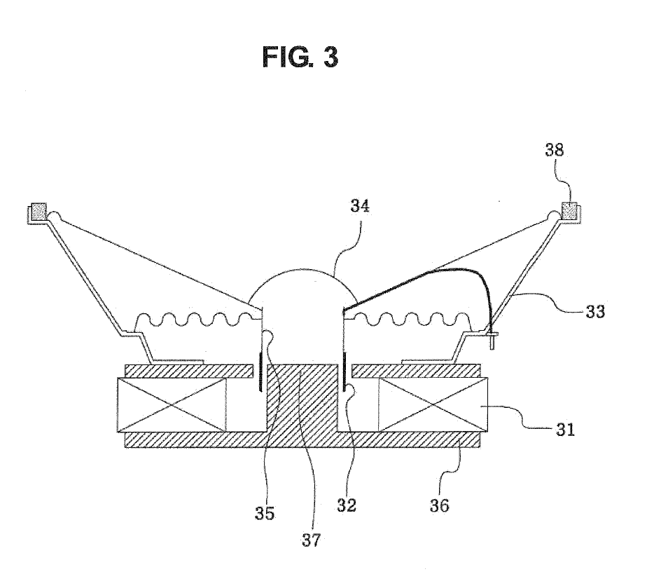

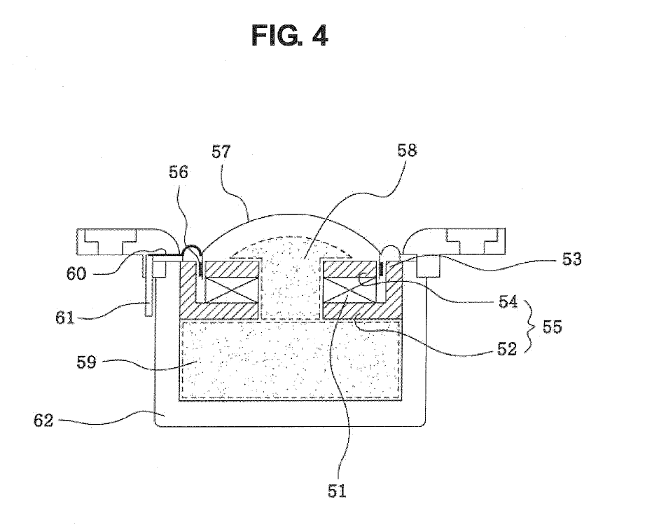

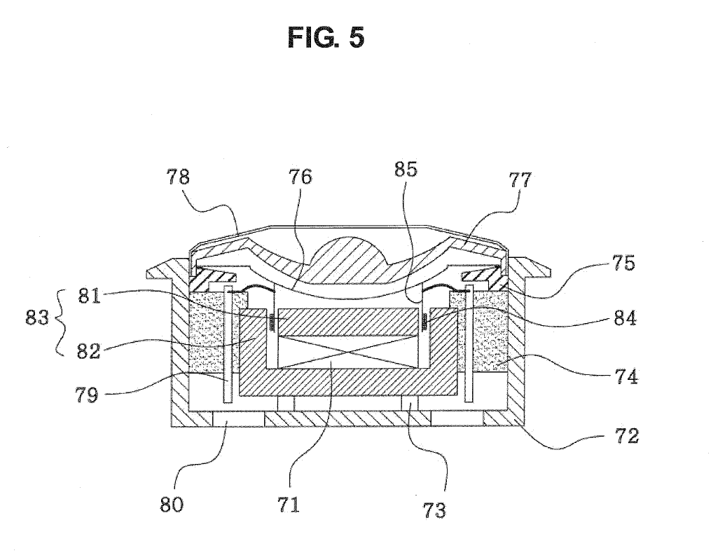

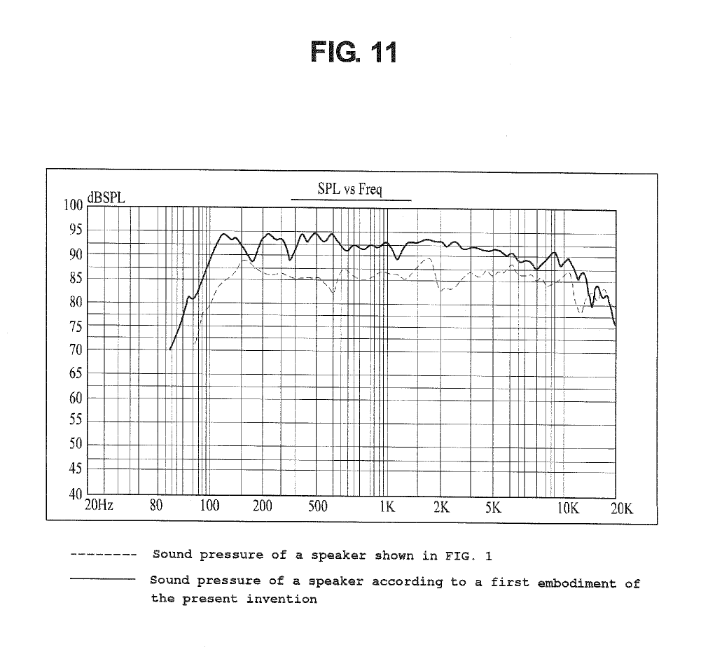

FIG. 11 illustrates a graph showing a sound pressure and frequency characteristics of the speaker shown in FIG. 1 and the speaker according to the first embodiment of the present invention. This graph refers to a case when a 1 m distance, a 1 W output, and 2.83V are applied to an 80 speaker, by using an LSM measurement equipment and a measurement microphone. As shown in FIG. 11, it is apparent that the sound pressure of the speaker according to the first embodiment of the present invention is 7 dB higher than that of the speaker shown in FIG. 1.

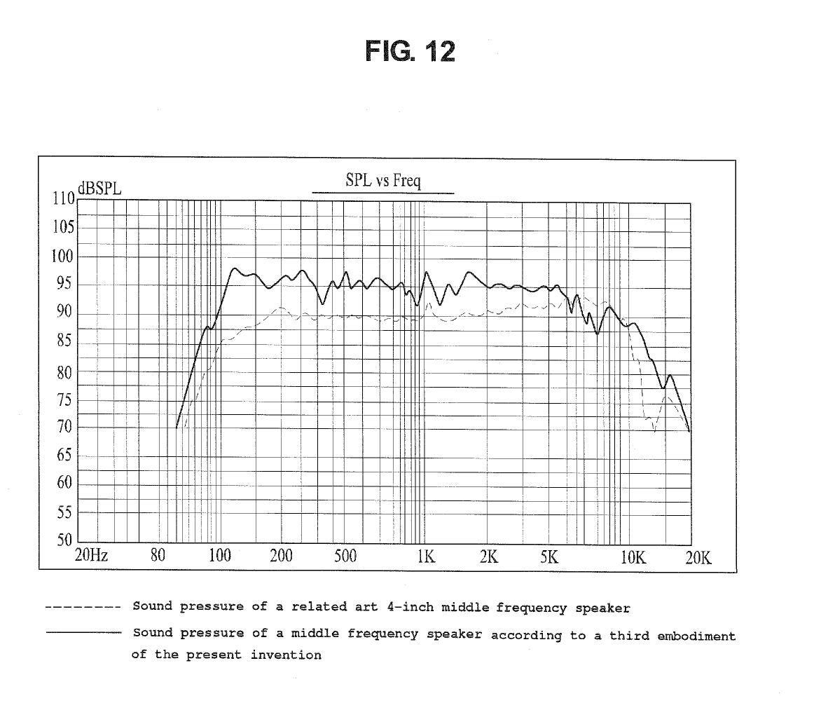

FIG. 12 illustrates a graph showing a sound pressure and frequency characteristics of a related art 4-inch speaker and the speaker according to the third embodiment of the present invention. This graph refers to a case when a 1 m distance, a 1 W output, and 2.83V are applied to an 80 speaker, by using an LSM measurement equipment and a measurement microphone. As shown in FIG. 11, it is apparent that the sound pressure of the speaker according to the third embodiment of the present invention is 6 dB higher than that of a related art 4-inch speaker.

The present invention may be applied to speakers converting electrical signals to sound.

What is claimed is:

1. A speaker, comprising:
a magnetic circuit and a vibration system, and
wherein the magnetic circuit comprises:
a magnetic having a ring shape, wherein a lower surface part has a first polarity, and wherein an upper surface part has a second polarity;
a first plate being fixed to the lower surface part of the ring-shaped magnet and extending towards a center of the ring;
a first magnetic gap providing unit being connected to the first plate and protruding upwards toward the first plate;
a second plate being fixed to the upper surface part of the ring-shaped magnet and extending towards a center of the ring; and
a second magnetic gap providing unit being connected to the second plate and protruding upwards toward the second plate.

2. The speaker of claim 1, wherein the first magnetic gap providing unit has the first polarity, and wherein the second magnetic gap providing unit has the second polarity.

3. The speaker of claim 1, wherein the first magnetic gap providing unit and the second magnetic gap providing unit are spaced apart from one another, so as to create a magnetic gap.

4. The speaker of claim 3, wherein the vibration system comprises:
a voice coil corresponds to a wire being supplied with electrical signals, the voice coil being located with the magnetic gap and performing mechanical movements in accordance with the electrical signals and a magnetic field formed within the magnetic gap;
a bobbin being wound by the voice coil and delivering vibration of the voice coil;
a diaphragm receiving the vibration of the voice coil from the bobbin and vibrating, thereby generating sound; and
an edge part being connected to an upper surface part of the second plate and supporting the diaphragm.

5. The speaker of claim 4, wherein the upper surface part of the second plate has a step structure, and wherein the edge part is fixed to the step structure.

6. The speaker of claim 4, wherein, based upon a center point of the ring, the vibration system is formed inside the magnetic circuit.

7. The speaker of claim 4, further comprising a damper having one end fixed to the diaphragm and having another end fixed to the first magnetic gap providing unit, and controlling a vibration range of the diaphragm.

8. The speaker of claim 4, further comprising a magnetically shielding magnet configured to prevent a magnetic flux of the magnet from flowing to the outside.

9. The speaker of claim 4, further comprising:
a vent hole cap covering an upper surface of the diaphragm and having a plurality of vent holes; and
a lower surface part covering the lower surface of the diaphragm.
